(19) United States
(12) Patent Application Publication
(10) Pub. No.: US 2003/0052311 A1
(43) Pub. Date: Mar. 20, 2003

(54) Two-photon absorption composition

(76) Inventors: Yoshio Inagaki, Ashigara-shi (JP); Masaharu Akiba, Ashigara-shi (JP); Akinori Harada, Ashigara-shi (JP); Takeharu Tani, Ashigara-shi (JP)

Correspondence Address: BIRCH STEWART KOLASCH & BIRCH, PO BOX 747, FALLS CHURCH, VA, 22040-0747, US

(21) Appl. No.: 10/188,959

(22) Filed: Jul. 5, 2002

(30) Foreign Application Priority Data
Jul. 6, 2001 (JP) P.2001-206780
Jul. 12, 2001 (JP) P.2001-212310

(51) Int. Cl. G03C 1/00

(52) U.S. Cl. 252/600

(57) ABSTRACT

Disclosed is a two-photon absorption composition containing a two-photon absorbing compound having a two-photon absorption cross-section of 10² GM (1 GM=1×10⁻⁵⁰ cm⁴ s molecule⁻¹ photon⁻¹) or more. The high sensitive two-photon absorption composition which can bring about two-photon absorption using a laser having a relatively low power is provided.

### FIELD OF THE INVENTION

The present invention relates to a two-photon absorption composition containing a compound having a large two-photon absorption cross-section excited by only strong light. It can be utilized for an optical information recording medium, an optical modulation element, an optical arithmetic element or shaping by photopolymerization.

### BACKGROUND OF THE INVENTION

Usually, a substance is excited by absorbing one photon of energy corresponding to excitation energy, and a photon of energy not coming up to this energy is not absorbed. However, when the intensity of light is very strong, two photons in which the sum of photon energy corresponds to excitation energy are concurrently absorbed in some cases. The utilization of this property allows photoreaction to occur only in the vicinity of a focus on which light is focused with a lens, and by selecting any position of a space, an excited state can be produced and utilized. However, two-photon absorption is usually very difficult to occur, so that a substance having high two-photon excitation efficiency has been desired. The two-photon absorption cross-section indicating ease of occurrence of two-photon absorption is usually as very small as about 1 GM (1 GM=1×10⁻⁵⁰ cm⁴ s molecule⁻¹ photon⁻¹). However, substances showing a relatively large two-photon absorption cross-section of hundreds or thousands of GM units have recently been found.

Examples of the compounds having a relatively large two-photon absorbing cross-sectional area are described in, for example, Reinhardt et al., Chemistry of Materials, 10, 1863 (1998), M. Albota et al., Science, 281, 1653 (1998), M. Rumi et al, Journal of the American Chemical Society, 122, 9500 (2000), J. D. Bhawalkar et al., Optic Communications, 124, 33 (1996), S. G. He et al., Applied Physics Letters, 67, 2433 (1995), P. N. Prasad et al., Nonlinear Optics, 21, 39 (1999), S. G. He et al., Journal of Applied Physics, 81, 2529 (1997), S. J. Chung et al., Journal of Physical Chemistry B, 103, 10741 (1999), S. G. He et al., Optics Letters, 20, 435 (1995) and J. W. Perry et al., Nonlinear Optics, 21, 225 (1999).

However, the compounds having such a cross-sectional area have not been practical yet, because they require a very high-power laser. Further, in order to make it easy to use their excitation energy depending on their purpose, it has been necessary to devise to combine various functional substances. Furthermore, the compounds having a relatively large two-photon absorbing cross-sectional area, which have hitherto been reported, are inconvenient in some uses, because they emit strong fluorescence. For example, when they are used in a so-called optical information recording medium in which information is recorded by bringing about changes in the state of a recording layer due to light irradiation, and the changes are read as changes in absorption or reflection of light, signal light is difficult to be distinguished from the fluorescence emitted, which causes noise. When they are used in so-called two-photon photo-shaping in which an arbitrary shape is formed by curing only a portion irradiated by use of a high-power laser in combination with a photo-hardening resin, the visibility of the shape is poor unless the wavelength of illumination is selected, because the shaped article completed sparkles emitting fluorescence. The problem has therefore been encountered that it can not be used in the vicinity of a light-sensitive material such as a photographic film. Accordingly, a two-photon absorption composition which does not substantially emit fluorescence has been desired.

### SUMMARY OF THE INVENTION

An object of the present invention is to provide a high sensitive two-photon absorption composition which can bring about two-photon absorption using a laser having a relatively low power. Another object of the present invention is to provide a two-photon absorption composition for making it easy to link energy in an excited state produced as a result of two-photon absorption to physical and chemical changes. Still another object of the present invention is to provide a two-photon absorption composition which does not substantially emit fluorescence.

As a result of intensive investigation, the present inventors have given attention to that it is important to use a compound efficiently bringing about two-photon absorption in combination with a compound having a function for effectively utilizing its excitation energy, and have discovered that the above-mentioned objects are attained by the following two-photon absorption composition:

(1) A two-photon absorption composition containing a two-photon absorbing compound having a two-photon absorption cross-section of 10² GM (1 GM=1×10⁻⁵⁰ cm⁴ s molecule⁻¹ photon⁻¹) or more;

(2) The two-photon absorption composition described in (1), which contains a compound which can be excited by energy transfer from an excited state of the two-photon absorbing compound;

(3) The two-photon absorption composition described in (1) or (2), which contains a compound emitting visible fluorescence;

(4) The two-photon absorption composition described in (3), wherein the one-photon absorbing maximum wavelength of the compound emitting visible fluorescence is longer than that of the two-photon absorbing compound;

(5) The two-photon absorption composition described in any one of (1) to (4), which contains a polymerizable monomer;

(6) The two-photon absorption composition described in anyone of (1) to (5), which contains a polymerization initiator;

(7) The two-photon absorption composition described in (6), wherein the one-photon absorbing maximum wavelength of the polymerization initiator is longer than that of the two-photon absorbing compound;

(8) The two-photon absorption composition described in any one of (1) to (7), which contains a polymer binder;

(9) A two-photon absorption composition containing a two-photon absorbing compound having a two-photon absorption cross-section of 10² GM (1 GM=1×10⁻⁵⁰ cm⁴ s molecule⁻¹ photon⁻¹) or more and a fluorescence quenching agent;

(10) The two-photon absorption composition described in (9), which contains a polymer binder;

(11) The two-photon absorption composition described in (9) or (10), wherein the polymer binder is crosslinked with a crosslinking agent;

(12) The two-photon absorption composition described in any one of (9) and (11), wherein the two-photon absorbing compound is at least one of compounds represented by general formulas (1) to (5) given later; and

(13) The two-photon absorption composition described in any one of (9) to (12), wherein the fluorescence quenching agent is at least one compound selected from the group of strong electron-accepting compounds, the group of strong electron-donating compounds and the group of heavy metal complex compounds.

### DETAILED DESCRIPTION OF THE INVENTION

Embodiments of the two-photon absorption composition s of the present invention will be described in detail below.

The operating principle of compositions used as the two-photon absorption composition s of the present invention and responsive only to strong light to achieve a function will be described. When a substance is exposed to light, energy corresponding to one photon is usually absorbed. Even when light having such a wavelength that it does not cause this one-photon absorption is used, in the case that its intensity is very strong, two photons in which the sum of photon energy corresponds to excitation energy are concurrently absorbed in some cases. The two-photon absorption cross-section indicating ease of occurrence of two-photon absorption is usually as very small as about 1 GM (1 GM=1×10⁻⁵⁰ cm⁴ s molecule⁻¹ photon⁻¹). However, substances showing a relatively large two-photon absorbing cross-sectional area of hundreds or thousands of GM units have recently been found. Even when light in a wavelength region having no light absorption band is used, in the case that a light source very strong in intensity such as a high-power laser is used, the use of such substances allows absorption of energy corresponding to two photons. For example, irradiation of a compound indicating an absorption maximum wavelength of one photon at 400 nm and having no absorption band at 800 nm with a high-power laser having a wavelength of 800 nm can produce an excited state near to an excited state developed when the compound is irradiated with light of 400 nm. In case that when this compound is excited with light of 400 nm, for example, fluorescence of 430 nm is emitted, also when the compound absorbs light of 800 nm, fluorescence of 430 nm is emitted. Further, when a compound absorbing light of 430 nm and emitting fluorescence of 460 nm coexists, irradiation with a high-power laser of 800 nm allows fluorescence of 460 nm to be emitted. Irradiation with a laser beam focused by a lens is characterized in that fluorescent is emitted only in the vicinity of a focus where photon density is high, not emitting light in the whole optical path, which allows three-dimensional position selection. When a mixture of a polymerization initiator and a polymerizable monomer or a polymerizable oligomer is used instead of the compound emitting fluorescence, polymerization can be allowed to occur only in the vicinity of the focus. Accordingly, a solid polymer of any shape can be produced. Further, the intensity of the focused laser beam decreases as the distance from the center of the beam increases, so that the size of a portion having a light intensity sufficient to induce two-photon excitation is smaller than the beam diameter, resulting in about 1/\sqrt{2} time, that is to say, about 0.7 time. The advantage is therefore provided that only a region finer than the minimum value of the beam diameter determined by the wavelength of light can be excited. The compositions of the present invention thus achieve the function.

However, in order to allow two-photon absorption to occur in such a degree that it can meet the objects of the present invention and more efficiently than two-photon absorption of coexisting materials such as a binder and a support, the two-photon absorption cross-section is preferably 100 GM or more, more preferably 1,000 GM or more, and particularly preferably from 100,000 GM to 1,000,000,000 GM, when the area is indicated by GM (Goppert-Mayers unit, that is to say, 1×10⁻⁵⁰ cm⁴ s molecule⁻¹ photon⁻¹) for convenience.

The measuring method of the two-photon absorption cross-section is described in, for example, Science, 280, 1653-1656 (1998) and Chemistry of Material, 11, 2899-2906 (1999).

The two-photon absorption cross-section is varied by the measuring condition.

When the femto second-laser is used as a light source, the value of the two-photon absorption cross-section become smaller than the value when the nano second-laser and the pico second-laser are used.

Accordingly, it is considered that the value of the two-photon absorption cross-section obtained by using the femto second is exact as compared with that obtained by using the nano second-laser and the pico second-laser is used.

Examples of the two-photon absorbing compounds used in the present invention include compounds represented by the following general formulas (1) to (5), as well as compounds described in the literatures cited in “DESCRIPTION OF THE RELATED ART” described above:

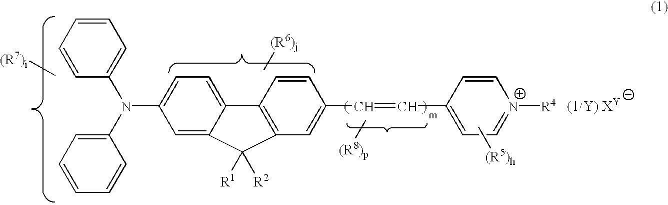

wherein R¹, R² and R⁴ each independently represents at least one group selected from a substituted or unsubstituted alkyl group, a substituted or unsubstituted alkenyl group, a substituted or unsubstituted alkynyl group, a substituted or unsubstituted aryl group and a heterocyclic group; R⁵ represents a substituent group, h represents an integer of 0 to 4, and a plurality of R⁵'s may be the same or different and may be combined with each other to form a ring, when h is an integer of 2 or more; R⁶represents a substituent group on two benzene rings, j represents an integer of 0 to 6, and a plurality of R⁶'s may be the same or different and may be combined with each other to form a ring, when j is an integer of 2 or more; R⁷ represents a substituent group on a benzene ring linked to N, i represents an integer of 0 to 10, and a plurality of R⁷'s may be the same or different and may be combined with each other to form a ring, when i is an integer of 2 or more; R⁸ represents a substituent group on a methine group, p represents an integer of 0 to 2, and a plurality of R⁸'s may be the same or different and may be combined with each other to form a ring, when p is 2; m represents an integer of 0 to 5; and X^{Y-} represents Y-valent organic or inorganic anion, and Y represents an integer of 1 to 5.

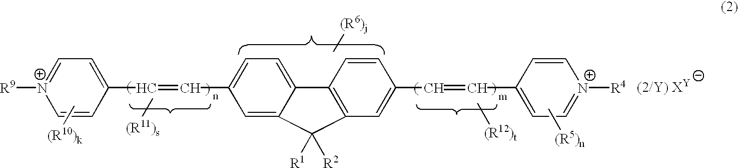

wherein R¹, R², R⁴ and R⁹ each independently represents at least one group selected from a substituted or unsubstituted alkyl group, a substituted or unsubstituted alkenyl group, a substituted or unsubstituted alkynyl group, a substituted or unsubstituted aryl group and a heterocyclic group; R⁵ and R¹⁰ each represents a substituent group, h and k each independently represents an integer of 0 to 4, and a plurality of R⁵'s and R¹⁰'s may each be the same or different and may each be combined with each other to form a ring, when h and k are each an integer of 2 or more; R⁶ represents a substituent group, j represents an integer of 0 to 6, and a plurality of R⁶'s may be the same or different and may be combined with each other to form a ring, when j is an integer of 2 or more; m and n each independently represents an integer of 0 to 5, R¹¹ and R¹² each represents a substituent group, s and t each independently represents an integer of 0 to 2, and a plurality of R¹¹'s and R¹²'s may each be the same or different and may each be combined with each other to form a ring, when s and t are each an integer of 2; and X^{Y-} represents Y-valent organic or inorganic anion, and Y represents an integer of 1 to 5.

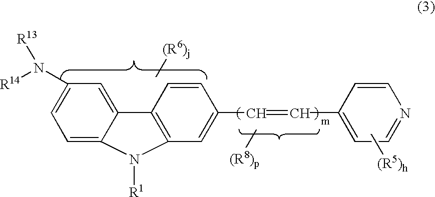

wherein R¹ represents at least one group selected from a substituted or unsubstituted alkyl group, a substituted or unsubstituted alkenyl group, a substituted or unsubstituted alkynyl group, a substituted or unsubstituted aryl group and a heterocyclic group; R⁵ represents a substituent group, h represents an integer of 0 to 4, and a plurality of R⁵'s may be the same or different and may be combined with each other to form a ring, when h is an integer of 2 or more; R⁶ represents a substituent group, j represents an integer of 0 to 6, and a plurality of R⁶'s may be the same or different and may be combined with each other to form a ring, when j is an integer of 2 or more; R⁸ represents a substituent group, p represents an integer of 0 to 2 m, and a plurality of R⁸'s may be the same or different and may be combined with each other to form a ring, when p is an integer of 2 or more; and m represents an integer of 0 to 5.

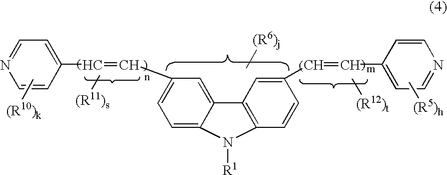

wherein R¹ represents at least one group selected from a substituted or unsubstituted alkyl group, a substituted or unsubstituted alkenyl group, a substituted or unsubstituted alkynyl group, a substituted or unsubstituted aryl group and a heterocyclic group; R⁵ and R¹⁰ each represents a substituent group, h and k each independently represents an integer of 0 to 4, and a plurality of R⁵'s and R¹⁰'s may each be the same or different and may each be combined with each other to form a ring, when hand k are each an integer of 2 or more; R⁶ represents a substituent group, j represents an integer of 0 to 6, and a plurality of R⁶'s may be the same or different and may be combined with each other to form a ring, when j is an integer of 2 or more; and m and n each independently represents an integer of 0 to 5, R¹¹ and R¹² each represents a substituent group, s and t each independently represents an integer of 0 to 2 n and 0 to 2 m, and a plurality of R¹¹'s and R¹²'s may each be the same or different and may each be combined with each other to form a ring, when s and t are each an integer of 2 or more.

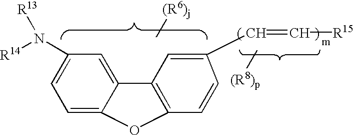

wherein R¹³ and R¹⁴ each independently represents at least one group selected from a substituted or unsubstituted alkyl group, a substituted or unsubstituted alkenyl group, a substituted or unsubstituted alkynyl group, a substituted or unsubstituted aryl group and a heterocyclic group; R⁶represents a substituent group, j represents an integer of 0 to 6, and a plurality of R⁶'s may be the same or different and may be combined with each other to form a ring, when j is an integer of 2 or more; R⁸ represents a substituent group, p represents an integer of 0 to 2 m, and a plurality of R⁸'s may be the same or different and may be combined with each other to form a ring, when p is an integer of 2 or more; m represents an integer of 0 to 5; and R¹⁵ represents a substituted or unsubstituted heterocyclic group.

Specific examples of the two-photon absorbing compounds include the following compounds, to which the scope of the present invention is not limited:

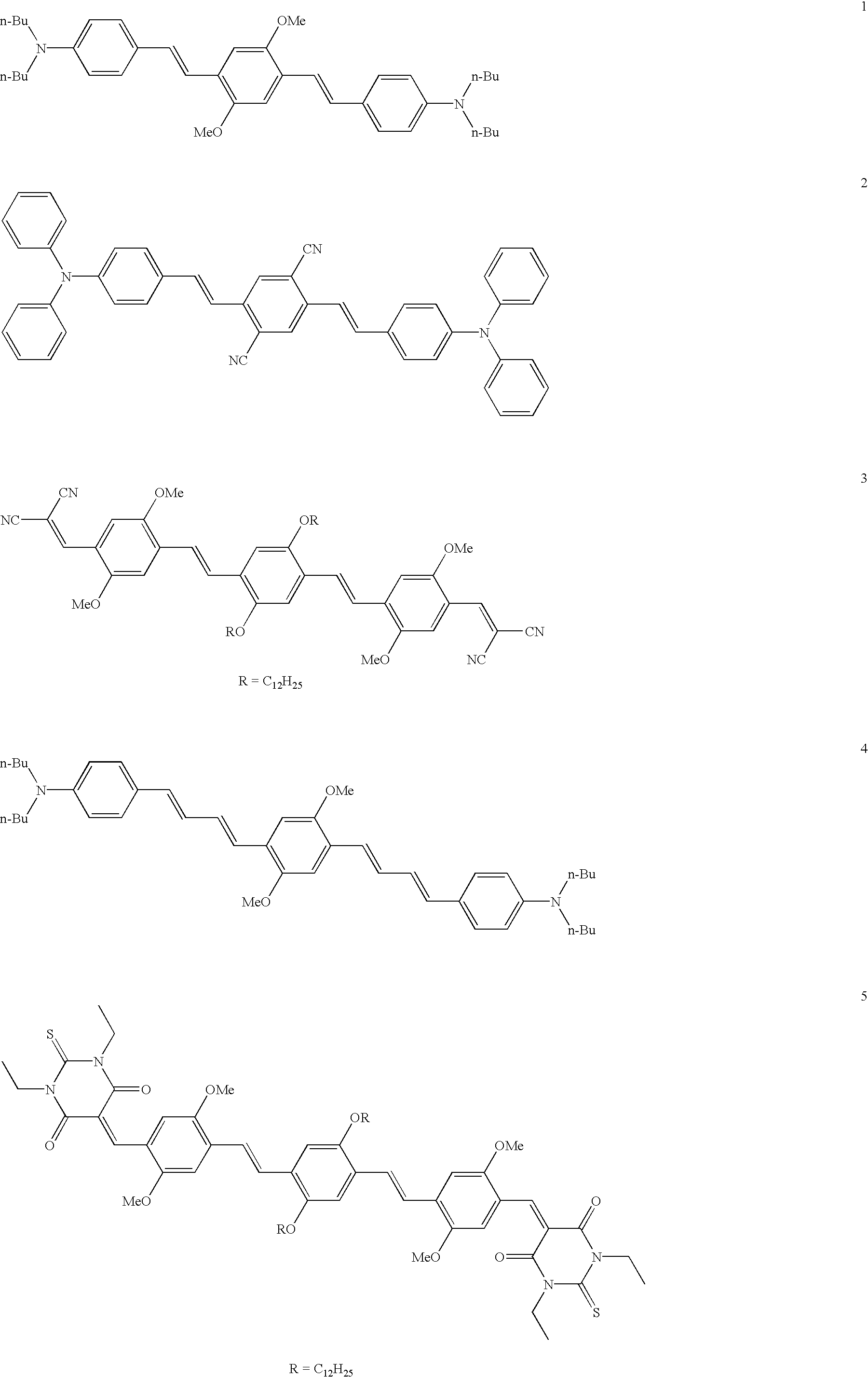

Although a compound having a large two-photon absorption cross-section easily reaches a two-photon excited state, it is necessary to devise to make it easy to use the excitation energy depending on the purpose. For example, when polymerization is tried to be initiated by two-photon excitation, low polymerization initiating ability of the excited state generated by excitation of the compound having a large two-photon absorption cross-section results in low polymerization initiating efficiency. It is therefore necessary to devise to design the compound itself having a large two-photon absorption cross-section to give high polymerization initiating ability on excitation, or to give high polymerization initiating ability to a compound excited by acceptance of the energy of the excited state generated by excitation of the compound having a large two-photon absorption cross-section. Further, an appropriate polymer binder, solvent or plasticizer maybe used in combination with the two-photon absorbing compound, thereby adjusting the properties thereof, for example, whether liquid or solid, or the viscosity thereof. Accordingly, in preferred embodiments of the compositions of the present invention, various functional compositions are used in combination with the compounds having a large two-photon absorption cross-section.

As the compounds which can be excited by energy transfer from the excited state of the two-photon absorbing compound used in the present invention, there are used various functional compounds. For example, the combined use of a fluorescent agent can generate light having a wavelength different from that of excitation light to provide a composition having a wavelength converting function. The combined use of a polymerization initiator can provide a two-photon polymerizable composition. In order to excite these compounds by energy transfer from the excited state of the two-photon absorbing compound, the one-photon excitation energy of these compounds is required to be smaller than that of the two-photon absorbing compound.

As the visible fluorescence-emitting compounds used in the present invention, there can be used various compounds, and they may be the two-photon absorbing compound itself used in the present invention. The visible fluorescence-emitting compounds other than the two-photon absorbing compound itself used in the present invention are required to be compounds which can accept the excitation energy of the two-photon absorbing compound. For this purpose, it is preferred that an overlapping of a fluorescence spectrum of the two-photon absorbing compound and an absorption spectrum of the visible fluorescence-emitting compound in a certain wavelength region, a requirement for occurrence of so-called Folster type energy transfer, is fulfilled. Although the visible fluorescence-emitting compounds include various compound groups, typical examples thereof include compound groups known as so-called fluorescent brightening agents, and various dyes used as luminescent materials of an organic EL (electroluminescent) device or as fluorescent markers.

Examples of the visible fluorescence-emitting compounds include the following compounds, to which the scope of the present invention is not limited:

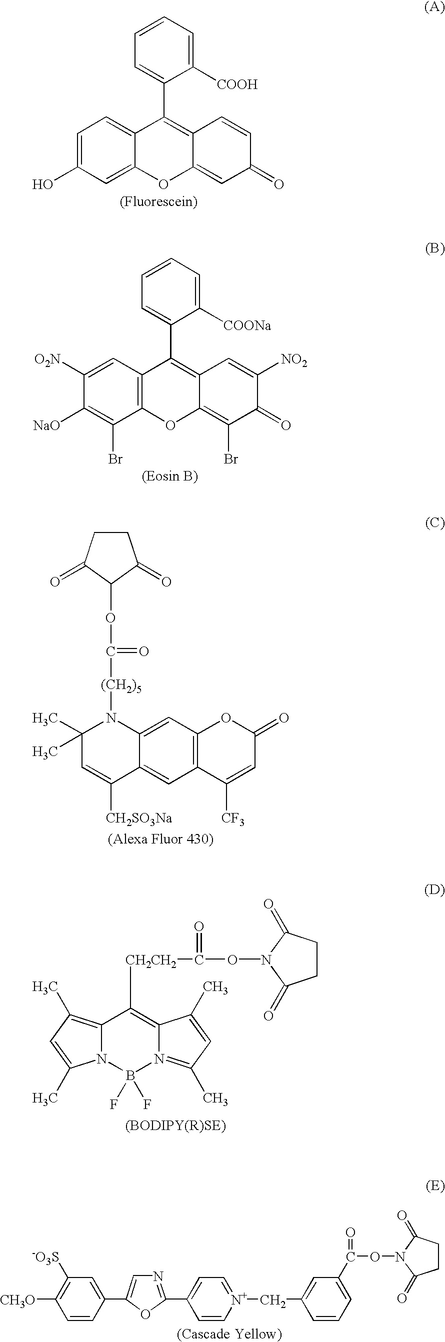

The fluorescence quenching agent used in the present invention is a compound inactivating the excited state of the two-photon absorbing compound by some mechanism. Examples thereof include (1) a compound which is excited by energy transfer from the excited state of the two-photon absorbing compound, but does not substantially emit fluorescence, (2) a compound preventing an excited electron from emitting light to return to its original state by injecting an electron into the excited state of the two-photon absorbing compound, and (3) a compound preventing an excited electron from emitting light to return to its original state by accepting an electron from the excited state of the two-photon absorbing compound. In (1), in order to excite the compound by energy transfer from the excited state of the two-photon absorbing compound, it is preferred that an overlapping of a fluorescence spectrum of the two-photon absorbing compound and an absorption spectrum of the visible fluorescence-emitting compound in a certain wavelength region, a requirement for occurrence of so-called Folster type energy transfer, is fulfilled, and the one-photon excitation energy of the compound is required to be smaller than that of the two-photon absorbing compound. In (2), in order to permit electron injection into the excited state of the two-photon absorbing compound, it is preferred that the compound has an occupied orbital of an energy level higher than that of a maximum occupied orbital of the two-photon absorbing compound. In (3), in order to permit electron acceptance from a compound preventing an excited electron from the excited state of the two-photon absorbing compound, it is preferred that the compound has an unoccupied orbital of an energy level lower than that of a minimum unoccupied orbital of the two-photon absorbing compound.

Even compounds emitting fluorescence when used alone can provide a situation in which harmful fluorescence is not substantially emitted. For example, when compounds fulfilling the requirement for occurrence of Folster type energy transfer are combined, and multistage energy transfer is repeated so as to allow a compound excited in a final stage of a chain of the energy transfer to emit fluorescence in a wavelength region in which a hindrance to the function of the two-photon absorbing compound is not substantially constituted, a state in which fluorescence is not substantially emitted can be achieved.

As the fluorescence quenching agents used in the present invention, there can be used various compounds. The compound which can accept the excitation energy of the two-photon absorbing compound is preferably a compound fulfilling an overlapping of a fluorescence spectrum of the two-photon absorbing compound and an absorption spectrum of the visible fluorescence-emitting compound in a certain wavelength region, a requirement for occurrence of so-called Folster type energy transfer. Preferred is a compound in which an excitation singlet generated as a result of energy transfer is rapidly changed to an excitation triplet, or a compound in which a chemical change such as electron transfer occurs. The former is more preferred in that no unnecessary chemical change occurs. The fluorescence quenching agents include various compound groups. Typical examples thereof include the group of strong electron-accepting compounds (for example, a nitro compound, a quinone, a tetracyanoquinodimethane compound, an aminium and a diimmonium), the group of strong electron-donating compounds (for example, a hydrazine, a hydrazide, a hydroxylamine, a hydroquinone and a tetra-substituted boron anion) and the group of compounds containing high periodic elements such as heavy metal complexes (for example, a metallocene such as ferrocene, a bis(1,2-benzene thiolato)nickel complex, a heavy metal complex of an azo dye, a dipyrromethene metal complex, a porphyrin heavy metal complex, a heavy metal phthalocyanine and a heavy metal naphthalocyanine). These fluorescence quenching agents may also have another function, for example, the function of a photopolymerization initiator.

Examples of the fluorescence quenching agents include the following compounds, to which the scope of the present invention is not limited:

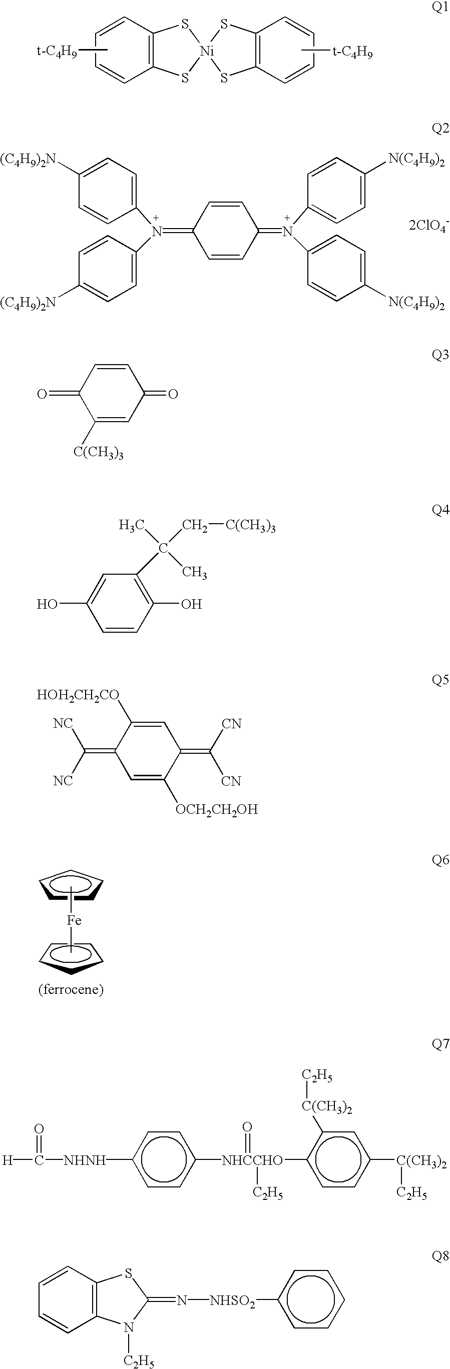

In the present invention, in order to impart photo-hardenability, a polymerizable monomer or oligomer may be used together as needed. The polymerizable monomers or oligomers include, for example, radical polymerizable compounds such as an acrylate and an acrylonitrile compound, and cationic polymerizable compounds such as a vinyl ether, a methylenedioxolane and an epoxide. In particular, as a liquid photo-hardening resin for photo-shaping, an epoxy compound is preferred in that its volume shrinkage is relatively small, and a urethane acrylate compound is preferred in terms of thermal characteristics and mechanical characteristics.

Specific examples of the photo-hardening resins include epoxy resins such as HS-681 manufactured by Asahi Denka Kogyo K. K., SOMOS 8100 manufactured by DMS-SOMOS, a SCR-8100 series manufactured by Japan Synthetic Rubber Co., Ltd. and SL-7540 manufactured by Vantico, and urethane acrylate compounds such as SCR-701 manufactured by D-MEK Ltd., and TSR-1938 manufactured by Teijin Ltd.

The polymerization initiators used in the present invention include radical generators, which are radical polymerization initiators, and acid generators and cation generators, which are cationic polymerization initiators. Examples of the radical generators include halides (such as an α-haloacetophenone and a trichloromethyltriazine compound), azo compounds (such as azobisisobutyronitrile), aromatic carbonyl compounds (such as a benzoin ester, a ketal, an acetophenone compound, an o-acyloxyiminoketone and an acylphosphine oxide), hexaarylbisimidazoles, peroxides and metal arene complexes (such as a ferrocene complex and a titanocene complex).

As the cationic polymerization initiators, there are mainly used compounds which can generate acids by light, and examples thereof include aromatic diazonium salts (such as 4-dodecyloxybenzenediazonium hexafluorophosphate), aromatic iodonium salts (such as di(p-tert-butylphenyl)iodonium hexafluorophosphate and tolylcumyliodonium tetrakis(penta-fluorophenyl)borate), aromatic sulfonium salts (such as triphenylsulfonium hexafluorophosphate) and metal arene complexes (such as a ferrocene complex and a titanocene complex).

Various examples of the photo-hardening agents and polymerization initiators are described, for example, in “Hikari Koka Gijutsu (Photo-Hardening Techniques)” published by Gijutsu Johosha (2000). Further, examples of the radical initiators are described in Japanese Patent Laid-Open No. 60296/1998 and literatures cited therein.

The composition of the present invention may be either liquid or solid depending on its use.

The composition of the present invention may further contain a polymer binder and a solvent as desired. Examples of the solvents include esters such as butyl acetate, ethyl lactate and cellosolve acetate; ketones such as methyl ethyl ketone, cyclohexanone and methyl isobutyl ketone; halogenated hydrocarbons such as dichloromethane, 1,2-dichloroethane and chloroform; amides such as N,N-dimethylformamide; sulfoxides such as dimethyl sulfoxide; sulfones such as sulfolane; hydrocarbons such as cyclohexane and toluene; ethers such as tetrahydrofuran, ethyl ether and dioxane; alcohols such as ethanol, n-propanol, isopropanol, n-butanol and diacetone alcohol; fluorine-based solvents such as 2,2,3,3-tetrafluoropropanol; and glycol ethers such as ethylene glycol monomethyl ether, ethylene glycol monoethyl ether and propylene glycol monomethyl ether. The above-described solvents can be used either alone or as a combination of two or more, considering the solubility of the compound used. the composition of the present invention may further contain various additives such as an antioxidant, an UV absorber, a plasticizer and lubricant, depending on its purpose.

The composition of the present invention may be either liquid or solid depending on its use.

When the polymer binder is used together as a material for the recording layer, the amount of the polymer binder ranges generally from a 0.01-fold to 50-fold excess (weight ratio), and preferably from a 0.1-fold to 5-fold excess (weight ratio), in relation to the two-photon absorbing compound. The concentration of the two-photon absorbing compound contained in the composition thus prepared ranges generally from 0.01% to 10% by weight, and preferably from 0.1% to 5% by weight.

As the binder used in the two-photon absorbing compound of the present invention, there is used a well-known thermoplastic resin, thermosetting resin, reactive resin, electron beam-hardening resin, UV-hardening resin or visible light-hardening resin, or a mixture thereof. It is preferred that the thermoplastic resin has a softening temperature of 150° C. or less, an average molecular weight of 10000 to 300000 and a degree of polymerization of about 50 to about 2000, preferably about 200 to 700. The thermoplastic resins used include, for example, a vinyl chloride-vinyl acetate copolymer, a vinyl chloride copolymer, a vinyl chloride-vinyl acetate-vinyl alcohol copolymer, a vinyl chloride-vinyl alcohol copolymer, a vinyl chloride-vinylidene chloride copolymer, a vinyl chloride-acrylonitrile copolymer, an acrylate-acrylonitrile copolymer, an acrylate-vinylidene chloride copolymer, an acrylate-styrene copolymer, a methacrylate-acrylonitrile copolymer, a methacrylate-vinylidene chloride copolymer, a methacrylate-styrene copolymer, a urethane elastomer, a nylon-silicone resin, a nitrocellulose-polyamide resin, polyvinyl fluoride, a vinylidene chloride-acrylonitrile copolymer, a butadiene-acrylonitrile copolymer, a polyamide resin, polyvinyl butyral, a cellulose derivative (such as cellulose acetate butyrate, cellulose diacetate, cellulose triacetate, cellulose propionate, nitrocellulose, ethyl cellulose, methyl cellulose, propyl cellulose, methyl ethyl cellulose, carboxymethyl cellulose or acetylcellulose), a styrene-butadiene copolymer, a polyester resin, a polycarbonate resin, a chlorovinyl ether-acrylate copolymer, an amino resin, various synthetic rubber thermoplastic resins and a mixture thereof.

The molecular weight of the thermosetting resin or the reactive resin is 200000 or less in the state of a coating solution, and increases to infinity by reaction such as condensation or addition by heating and moistening after coating and drying. Of these resins, resins are preferred which are not softened or not melted until the resins are thermally decomposed. Specific examples thereof include a phenol resin, a phenoxy resin, an epoxy resin, a polyurethane resin, a polyester resin, a polyurethane polycarbonate resin, a urea resin, a melamine resin, an alkyd resin, a silicone resin, an acrylic reactive resin (electron beam-hardening resin), an epoxy-polyamide resin, a nitrocellulose-melamine resin, a mixture of a high-molecular weight polyester resin and an isocyanate prepolymer, a mixture of a methacrylate copolymer and a diisocyanate prepolymer, a mixture of a polyester polyol and polyisocyanate, a urea-formaldehyde resin, a mixture of low-molecular weight glycol/high-molecular weight diol/triphenylmethane triisocyanate, a polyamine resin, a polyimine resin and a mixture thereof. Each of these thermoplastic, thermosetting and reactive resins usually contains 1 to 6 kinds of acidic groups such as a carboxylic acid (COOM), a sulfinic acid, a sulfenic acid, a sulfonic acid (SO₃M), a phosphoric acid (PO (OM) (OM)), a phosphonic acid, a sulfuric acid (OSO₃M) and an ester group thereof (M is H, an alkali metal, an alkaline earth metal or a hydrocarbon group); amphoteric groups such as an amino acid, an aminosulfonic acid, a sulfate or phosphate of an amino alcohol, a sulfobetaine, a phosphobetaine and an alkylbetaine; an amino group, an imino group, an imido group, an amido group, a hydroxyl group, an alkoxyl group, a thiol group, an alkylthio group, a halogen group (F, Cl, Br or I), a silyl group, s siloxane group, an epoxy group, an isocyanate group, a cyano group, a nitrile group, an oxo group, an acryl group and a phosphine group, as a functional group or functional groups other than the main functional group. It is preferred that each functional group is contained in an amount of 1×10⁻⁶ mol to 1×10⁻² mol. per gram of resin.

Examples of the polymer binders include natural organic polymer substances such as gelatin, dextran, rosin and rubber; and synthetic organic polymers such as hydrocarbon resins such as polyethylene, polypropylene, polystyrene and polyisobutylene, vinyl resins such as polyvinyl chloride and polyvinylidene chloride, acrylic resins such as polymethyl acrylate and polymethyl methacrylate, and initial condensation products of thermosetting resins such as polyvinyl alcohol, chlorinated polyethylene, a butyral resin, a rubber derivative and a phenol-formaldehyde resin.

These binders are used either alone or in combination. In addition, additives are added thereto. As for the mixing ratio of the binder to the two-photon absorption composition of the present invention, the binder is preferably used in an amount ranging from 5 to 50000 parts by weight based on 100 parts by weight of the two-photon absorption composition. As the additives, there may be added a dispersing agent, a lubricant, an antistatic agent, an antioxidant, an antifungal agent, a coloring agent and a solvent as needed.

It is preferred that a crosslinking agent is added to the two-photon absorption composition to crosslink the polymer binder, thereby enhancing dimensional stability or adherence to a support. The crosslinking agent is preferably a compound having a plurality of functional groups reactive to active hydrogen atoms of hydroxyl groups, amino groups or carboxyl groups of the polymer binder. Examples thereof include polyaldehydes, polyacid halides, polyacid anhydrides, polyvinyl sulfone, cyanuric acid chloride derivatives and polyisocyanates. Of these, particularly preferred examples of the polyisocyanates include isocyanates such as tolylene diisocyanate, 4,4′-diphenylmethane diisocyanate, hexa-methylene diisocyanate, xylylene diisocyanate, naphthylene-1,5-diisocyanate, o-toluidine diisocyanate, isophorone diisocyanate and triphenylmethane triisocyanate; products of the isocyanates and polyalcohols; polyisocyanates (2- to 10-mers) produced by condensation of isocyanates; and products of polyisocyanates and polyurethanes, whose end functional groups are isocyanates. Suitably, these polyisocyanates have an average molecular weight of 100 to 20000. These polyisocyanates are commercially available under the following trade names: Coronate L, Coronate HL, Coronate 2030, Coronate 2031, Millionate MR and Millionate MTL (manufactured by Nippon Polyurethane Industry Co., Ltd.); Takenate D-102, Takenate D-110N, Takenate D-200, Takenate D-202, Takenate 300S and Takenate 500 (manufactured by Takeda Chemical Industries, Ltd.); and Sumidur T-80, Sumidur 44S, Sumidur PF, Sumidur L, Sumidur N, Desmodur L, Desmodur IL, Desmodur N, Desmodur HL, Desmodur T65, Desmodur 15, Desmodur R, Desmodur RF, Desmodur SL and Desmodur Z4273 (manufactured by Sumitomo Bayer Co., Ltd.). These can be used either alone or as a combination of two or more of them, utilizing the difference in hardening reactivity. For the purpose of accelerating the hardening reaction, the polyisocyanate can also be used in combination with a hydroxyl group-containing compound (such as butanediol, hexanediol, a polyurethane having a molecular weight of 1000 to 10000 or water), an amino group-containing compound (such as monomethylamine, dimethylamine or trimethylamine), a metal oxide catalyst or an iron acetylacetonate catalyst. It is desirable that these hydroxyl group- or amino group-containing compounds are poyfunctional. The amount of the polyisocyanate used is preferably from 2 to 70 parts by weight, and more preferably from 5 to 50 parts by weight, per 100 parts by weight of the total amount of the polymer binder and the polyisocyanate in the two-photon absorbing compound.

### EXAMPLES

The present invention will be described in more detail by reference to the following examples. It is easily understood by those skilled in the art that changes in the composition, ratio and order of operations shown herein can be made without departing from the spirit of the present invention. Accordingly, the present invention should not be limited to the following examples. In the example, all parts are by weight.

### Example I-1

Example of Wavelength-Converting Composition

| | | |
|---|---|---|
| Two-photon absorbing compound (14) | 1 | part |
| Visible fluorescence-emitting compound (fluorescein) | 10 | parts |
| Binder (MR110T manufactured by Nippon Zeon Co., Ltd.) | 200 | parts |
| Binder (UR-5500 manufactured by Toyobo Co., Ltd., 30%) | 280 | parts |
| Diluent (methyl ethyl ketone/cyclohexanone = 2/1) | 5000 | parts |
| Crosslinking agent (Coronate 3041, 50%) | 100 | parts |

The above ingredients were mixed to obtain a homogeneous transparent liquid composition. This composition had no absorption band in a near-infrared region in the vicinity of 780 nm.

This composition was placed in a quartz cell of 1 cm square, and irradiated in a dark place with a laser beam having a wavelength of 780 nm, an average power of 40 mW, a peak power of 7 kW, a pulse width of 100 fs and a repetition frequency of 48 MHz. As a result, bluish green luminescence was observed. This proved that the near-infrared light was converted to visible light.

### Comparative Example I-1

A liquid composition was obtained in the same manner as in Example I-1 with the exception that two-photon absorbing compound (14) was not added. Although this composition was irradiated in the dark place with the laser beam in the same manner as with Example I-1, no luminescence of visible light was observed.

### Example I-2

Examples of Photopolymerization Compounds

(Composition of Polymerization Solution)

| | | |
|---|---|---|
| Two-photon absorbing compound (Table I-1) | 1 | part |
| UV-hardening resin (SCR-701 manufactured by | 1000 | parts |
| D-MEK Ltd.) | | |

### COMPARATIVE EXAMPLE

(Composition of Polymerization Solution for Comparison)

The UV-hardening resin (SCR-701 manufactured by D-MEK Ltd.) was used without adding the two-photon absorbing compound. This composition had no absorption band in a near-infrared region in the vicinity of 780 nm.

Performance Evaluation:

A laser beam having a wavelength of 780 nm, an average power of 40 mW, a peak power of 7 kW, a pulse width of 100 fs and a repetition frequency of 48 MHz was concentrated to about 100 μm through a lens having a focal length of 300 mm, and each polymerization solution was irradiated therewith. It was visually observed whether hardening occurred or not.

TABLE I-1

| Two-Photon Absorbing | Occurrence or Non- | |
|---|---|---|
| Compound | occurrence of Hardening | Remark |
| Not used | Not occurred | Comparison |
| 1 | Occurred | Invention |
| 4 | Occurred | Invention |
| 11 | Occurred | Invention |
| 12 | Occurred | Invention |
| 13 | Occurred | Invention |
| 14 | Occurred | Invention |
| 15 | Occurred | Invention |

As is apparent from the results of evaluation described above, the compositions of the present invention are high in sensitively to light having a wavelength corresponding to two-photon excitation.

### Example I-3

Comparison of Stability of Photopolymerizable Composition

(Composition of Polymerization Solution)

| | | |
|---|---|---|
| Two-photon absorbing compound (Table I-2) | 1 | part |
| Epoxyacrylate-based UV-hardening resin | 1000 | parts |

This composition had no absorption band in a near-infrared region in the vicinity of 780 nm.

### COMPARATIVE EXAMPLE

The same procedure as in Example I-3 was carried out, except that the two-photon absorbing compound was not added.

This composition had no absorption band in a near-infrared region in the vicinity of 780 nm.

Performance Evaluation:

A laser beam having a wavelength of 780 nm, an average power of 40 mW, a peak power of 7 kW, a pulse width of 100 fs and a repetition frequency of 48 MHz was concentrated to about 100 μm through a lens having a focal length of 300 mm, and each polymerization solution was irradiated therewith. It was visually observed whether hardening occurred or not.

And then, the lowest power in which the hardening can be confirmed was measured.

The different between the above obtained value and the value when the two-photon absorbing compound is not added is shown as the sensitivity difference in the Table I-2 below.

As this difference is larger, higher sensitivity is obtained.

The photopolymerizable composition was allowed to stand in the room for 4 days, and then the same evaluation as described above was carried out and the sensitivity fluctuation of the polymerizable composition was compared.

The results are shown in Table I-2 below.

TABLE I-2

| | | Sensitivity | |
|---|---|---|---|
| | | Difference | |
| Two-Photon | Sensitivity | After Storage | Sensitivity |
| Absorbing | Difference | for 4 days | Fluctuation |
| Compound | (mW) | (mW) | (mW) |
| Not used | 0 (standard) | 0 (standard) | 0 (standard) |
| 1 | 5.8 | 6.6 | −1.4 |
| 4 | 7.0 | 6.1 | −0.9 |
| 11 | 5.8 | 5.6 | −0.2 |
| 12 | 5.8 | 5.7 | −0.1 |

As is apparent from the results of evaluation described above, the compositions of the present invention are high in sensitivity to light having a wavelength corresponding to two-photon excitation.

Particularly, it is seen that when the compound such as Compound 12 corresponding to formula (2) is used, the sensitivity fluctuation of the polymerizable composition is small.

According to the compositions of the present invention, the effect is obtained that the sensitivity to light having a wavelength corresponding to two-photon excitation is high.

### Example II-1

| | | |
|---|---|---|
| Two-photon absorbing compound (14) | 1 | part |
| Fluorescence quenching agent (Q10) | 10 | parts |
| Binder (MR110T manufactured by Nippon Zeon Co., Ltd.) | 200 | parts |
| Binder (UR-5500 manufactured by Toyobo Co., Ltd., 30%) | 280 | parts |
| Diluent (methyl ethyl ketone/cyclohexanone = 2/1) | 5000 | parts |
| Crosslinking agent (Coronate 3041, 50%) | 100 | parts |

The above ingredients were mixed to obtain a homogeneous transparent liquid composition. This composition had no absorption band in a near-infrared region in the vicinity of 780 nm.

This composition was placed in a quartz cell of 1 cm square, and irradiated in a dark place with a laser beam having a wavelength of 780 nm, an average power of 40 mW, a peak power of 7 kW, a pulse width of 100 fs and a repetition frequency of 48 MHz. As a result, a change in the index of refraction was observed at an irradiated portion. That is to say, this proved that the change occurred by absorption of the near-infrared laser light. This composition coated was irradiated with an ultraviolet lamp, but such a remarkable fluorescent color as to be obtained in Comparative Example II-2 was not observed.

### Comparative Example II-1

A liquid composition was obtained in the same manner as in Example II-1 with the exception that two-photon absorbing compound (14) was not added. This composition was applied onto a TAC film, dried and irradiated with the laser beam in the same manner as with Example II-1. However, no change in the index of refraction was observed at an irradiated portion, and this proved that the near-infrared laser light was not absorbed so sufficiently as to cause the change. This composition coated was irradiated with an ultraviolet lamp, but such a remarkable fluorescent color as to be obtained in Comparative Example II-2 was not observed.

### Comparative Example II-2

A liquid composition was obtained in the same manner as in Example II-1 with the exception that the fluorescence quenching agent was not added. This composition was applied onto a TAC film, dried and irradiated with the laser beam in the same manner as with Example II-1. Although a change in the index of refraction was observed at an irradiated portion, it was observed with the naked eye that the whole coated film glowed in a fluorescent color when irradiated with an ultraviolet lamp.

It is known that the composition of the present invention has the preferred effects of causing the change by two-photon absorption and significantly inhibiting the occurrence of fluorescence.

The entitle disclosure of each and every foreign patent application from which the benefit of foreign priority has been claimed in the present application is incorporated herein by reference, as if fully set forth herein.

While the present invention has been described in detail and with reference to specific embodiments thereof, it will be apparent to one skilled in the art that various changes and modifications can be made therein without departing from the spirit and scope thereof.

What is claimed is:

1. A two-photon absorption composition containing a two-photon absorbing compound having a two-photon absorption cross-section of 10² GM (1 GM=1×10⁻⁵⁰ cm⁴ s molecule⁻¹ photon⁻¹) or more.

2. The two-photon absorption composition as claimed in claim 1, which contains a compound which can be excited by energy transfer from an excited state of the two-photon absorbing compound.

3. The two-photon absorption composition as claimed in claim 1, which contains a compound emitting visible fluorescence.

4. The two-photon absorption composition as claimed in claim 1, which contains a polymerizable monomer or a polymerizable oligomer.

5. The two-photon absorption composition as claimed in claim 1, which contains a polymerization initiator;

6. The two-photon absorption composition as claimed in claim 1, which contains a polymer binder.

7. The two-photon absorption composition as claimed in claim 1, which further contains a fluorescence quenching agent.

8. The two-photon absorption composition as claimed in claim 7, which contains a polymer binder.

9. The two-photon absorption composition as claimed in claim 7, wherein the polymer binder is crosslinked with a crosslinking agent
